(19) United States
(12) Patent Application Publication
(10) Pub. No.: US 2002/0150249 A1
(43) Pub. Date: Oct. 17, 2002

(54) Communication apparatus

(76) Inventors: Hideki Ohkita, Kanagawa-ken (JP); Shinji Yamadaji, Kanagawa-ken (JP); Hiroyuki Chaki, Kanagawa-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/105,379

(22) Filed: Mar. 26, 2002

(30) Foreign Application Priority Data
Mar. 27, 2001 (JP) 2001-090070

(51) Int. Cl. H04K 1/00

(52) U.S. Cl. 380/270

(57) ABSTRACT

A wireless communication apparatus and a wireless network. A first wireless communication apparatus transmits a connection request to a second wireless communication apparatus. The first wireless communication apparatus transmits key information (Key K) to the second wireless communication apparatus through an electric power line or another cable. The first wireless communication apparatus also transmits a check signal to the second wireless communication apparatus. The second wireless communication apparatus answers the check signal. The first wireless communication apparatus acknowledges the connection request to the second wireless communication apparatus, and thereby data communication is performed.

### CROSS-REFERENCE TO RELATED APPLICATIONS

This application claims the benefit of priority from prior Japanese Patent Application No. 2001-090070, filed Mar. 27, 2001, the contents of which are herein incorporated by reference.

### BACKGROUND OF THE INVENTION

1. Field of the Invention

This invention relates to an apparatus connected to a network, and more particularly an apparatus connected to the network through wireless communication.

2. Description of the Related Art

A wireless communication apparatus can not distinguish between an apparatus currently installed in user's house and an apparatus currently installed in an other's house. For this reason, when there is a wireless connection request, the apparatus currently installed in a user's house must be unjustly connected with an apparatus in an other's house. One method of distinguishing an apparatus requires the user to set up apparatus identification information for every apparatus. However, this is difficult for the user when there are many apparatus, or when the user is unfamiliar with the operation of the apparatus.

A wireless communication apparatus using personal identification numbers is disclosed in Japanese Patent Disclosure (kokai) No.H11-146452, for example. In this reference, a personal identification number is set in a registered cordless handset. ID information is then acquired from this registered cordless handset. This distinguishes whether it is unjust registration from an external cordless handset.

However, the main phone and all cordless handsets must be set up with the personal identification number with this technology. The quantity of work increases when there are many apparatus. Furthermore, the user needs to input a personal identification number. For this reason, it is hard to apply to the field of high security including copy control, such as transmission of image contents.

In IEEE1394 standard for the transmission of digital images in home AV apparatus, the copy protection means of DTCP (Digital Transmission Content Protection) is used for content protection. Each apparatus must have an authentication key from a public authentication authority. Digital images are only transmitted to an apparatus with a license from the authentication authority. By this method, digital images are not transmitted to unlicensed apparatus. IEEE1394 provides a plug-and-play function to operate at the first connection without a setup requirement. In IEEE1394, if it is a licensed apparatus, transmission of digital images is possible. The IEEE1394 cable connection works user's house.

The Wireless 1394 standard extended the IEEE1394 plug and play connections to wireless communication. In the wireless 1394 standard, the technology indicated by the reference is inapplicable, because a wireless plug-and-play connection from the apparatus of a neighboring house to the apparatus in the user's house may undesirably occur.

Thus, conventional wireless communication requires pre-registration of personal identification numbers for each apparatus. For this reason, the wireless 1394 standard is not available for wireless transmission of digital images. Wireless communication high security and a plug-and-play connection.

### BRIEF SUMMARY OF THE INVENTION

An object of the present invention is to address the problems in the existing art.

A further object of the present invention is to provide a secure wireless communication path.

In order to achieve the above objects, a communication apparatus, comprising; means for wireless-communicating to a second communication apparatus; means for cable-communicating to the second communication apparatus; means for determining whether the cable-communication is possible; and means for controlling wireless communication according to the result of the means for determining.

In order to achieve the above objects, a wireless communication apparatus, comprising; means for wireless-communicating to a second communication apparatus; means for cable-communicating to the second communication apparatus; means for checking existence of the second communication apparatus through the means for cable-communicating; means for transmitting apparatus discrimination information for discriminating one communication apparatus from the second communication apparatus through the means for cable-communicating after the existence of the second communication apparatus is checked through the means for cable-communicating; means for checking whether the second communication apparatus stores the apparatus discrimination information through the means for wireless-communicating; and means for controlling wireless data communication with the second communication apparatus according to the result of the means for checking whether the second communication apparatus stores the apparatus discrimination information.

In order to achieve the above objects, a wireless communication apparatus, comprising; means for wireless-communicating to a second communication apparatus; means for cable-communicating to the second communication apparatus; means for answering an existence check request from the second communication apparatus through the means for cable-communicating; means for receiving apparatus discrimination information through the means for cable-communicating; and means for answering a possession check request with the apparatus discrimination information through the means for wireless-communicating.

In order to achieve the above objects, a wireless communication apparatus, comprising; means for wireless-communicating to a second communication apparatus; means for cable-communicating to the second communication apparatus; means for transmitting key information to the second communication apparatus through the means for cable-communicating; means for transmitting predetermined data to the second communication apparatus through the means for wireless-communicating; means for receiving, from the second communication apparatus, the predetermined data encrypted using the key information; means for decrypting the encrypted data using the key information; and means for judging whether data from the means for decrypting is the same as the predetermined data.

In order to achieve the above objects, a wireless communication apparatus, comprising; means for wireless-communicating to a second communication apparatus; means for cable-communicating to the second communication apparatus; means for receiving key information from the second communication apparatus through the means for cable-communicating; means for receiving predetermined data from the second communication apparatus through the means for wireless-communicating; means for encrypting the predetermined data using the key information; and means for transmitting the encrypted data to the second communication apparatus.

Additional objects and advantages of the present invention will be apparent to persons skilled in the art from a study of the following description and the accompanying drawings, which are hereby incorporated in and constitute a part of this invention.

### BRIEF DESCRIPTION OF THE SEVERAL VIEWS OF THE DRAWING

A more complete appreciation of the present invention and many of the attendant advantages thereof will be readily obtained as the same becomes better understood by reference to the following detailed description when considered in connection with the accompanying drawings, wherein:

FIG. 1 is a functional block diagram of a wireless communication apparatus according to an embodiment of the present invention;

FIG. 2 is a functional block diagram of a wireless communication apparatus according to an embodiment of the present invention;

FIG. 3 is a functional block diagram showing a wireless communication connection in a house according to an embodiment of the present invention;

FIG. 4 is a diagram showing a wireless connection according to an embodiment of the present invention;

FIG. 5 is a diagram showing a procedure for eliminating an unauthorized wireless connection according to an embodiment of the present invention;

FIGS. 6(a) and 6(b) are diagrams of a connection method in a hand held wireless communication apparatus according to an embodiment of the present invention;

FIG. 7 is a diagram of an embodiment of the present invention using IEEE1394 cable.

FIG. 8 is a diagram of an embodiment of the present invention using IEEE1394 cable.

FIG. 9 is a diagram of a data flow between a first wireless communication apparatus and a second wireless communication apparatus according to an embodiment of the present invention;

FIGS. 10(a) and 10(b) are diagrams of apparatus identification information addresses according to an embodiment of the present invention;

FIG. 11 is a flowchart of an answering operation in a wireless communication apparatus according to an embodiment of the present invention;

FIG. 12 is a flowchart of a connection request in a wireless communication apparatus according to an embodiment of the present invention.

### DETAILED DESCRIPTION OF THE INVENTION

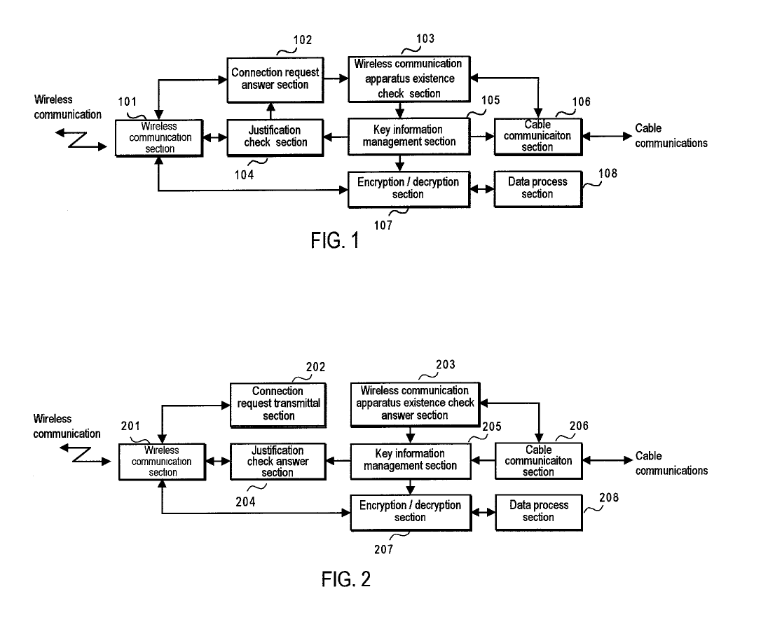

Embodiments of the present invention will be explained with references to FIGS. 1 through 12. A wireless communication apparatus 200 requests a wireless connection with a wireless communication apparatus 100. The wireless communication apparatus 100 receives and answers the connection request from the wireless communication apparatus 200.

### Composition of the Wireless Communication Apparatus which Answers a Connection Request

FIG. 1 is a functional block diagram of the wireless communication apparatus 100 which answers a connection request according to embodiment of the present invention.

In response to the connection request from the wireless communication apparatus 200, the wireless communication apparatus 100 checks whether the connection request is from a wireless communication apparatus in the same house. If the connection request is from a wireless communication apparatus in the same house, the wireless communication apparatus 100 establishes the wireless connection.

As shown in FIG. 1, the wireless communication apparatus 100 includes a wireless communication section 101, a connection request answer section 102, a wireless communication apparatus existence check section 103, a justification check section 104, a key information management section 105, a cable communication section 106, an encryption/decryption section 107, and a data process section 108.

Wireless communication section 101 communicates with other devices via wireless communication.

Connection request answer section 102 answers a connection request from the wireless communication apparatus 200.

Wireless communication apparatus existence check section 103 checks whether the wireless communication apparatus 200 is in the same house as the wireless communication apparatus 100.

Justification check section 104 checks the authorization of the wireless communication apparatus 200 through wireless communication section 101.

Key information management section 105 manages key information used for encryption.

Unlike wireless communication section 101, cable communication section 106 communicates via a cable.

Encryption/decryption section 107 encrypts/decrypts the communication data.

Data process section 108 carries out transmission and reception processing of the communication data.

Next, an operation of the wireless communication apparatus 100 will be explained.

Wireless communication section 101 receives the connection request from the other wireless communication apparatus, and outputs the connection request to connection request answer section 102.

Connection request answer section 102 will output ID information used for communication to wireless communication apparatus existence check section 103, if the connection request is inputted from wireless communication section 101. A MAC address peculiar to an apparatus is an example of the ID information for this communication. An ECHONET address defined by the ECHONET standard is another example ECHONET Specification Version 1.0 is currently found on a Homepage of ECHONET CONSORTIUM.(URL:http://www.echonet.gr.jp/english/index. htm). A node ID used by the IEEE1394 standard is yet another example.(URL:http://www.1394la.com/index.html). The ID information used for communication and the apparatus identification information for discriminating apparatus, such as the key information which this invention shows, are also examples.

The ID information used for communication is transmitted to communicate by plug-and-play connection without a separate setup procedure. Based on the ID information, the wireless communication apparatus 100 can not distinguish a requesting apparatus in the same house from a requesting apparatus in another house. In order to distinguish a connection request apparatus in the same house from a connection request apparatus outside of the house, apparatus identification information other than the ID information used for communication is needed.

Wireless communication apparatus existence check section 103 checks for the existence of another wireless communication apparatus that outputted a connection request through the cable communication section 106. This check is based on the ID information used for the communication inputted from the connection request answer section 102. For example, cable communication section 106 connects to an electric power line, a power line used for communication in the ECHONET, a telephone line, any other cables running through a house, etc. The wireless 1394 which extended IEEE1394 of a cable even to the wireless might also be used.

Wireless communication apparatus existence check section 103 outputs this check result to key information management section 105, when cable communication section 106 is able to check existence of the other wireless communication apparatus that advanced the connection request.

Key information management section 105 outputs the managed key information to justification check section 104. Moreover, key information management section 105 outputs the managed the key information to the wireless communication apparatus which checked the existence via cable communication section 106. In this embodiment, the key information is used as an apparatus identification information. The key information is, for example, a WEP key information that it is used by wireless LAN. The WEP key information is the key information with a length of 128 bits. Moreover, a setting information for wireless connection can also be used as the apparatus identification information.

As an example of the setting information for wireless connection, the setting information is a channel, ESS-ID, etc. When using the wireless LAN specified by IEEE802.11b or IEEE802.11a as a wireless connection means, it is necessary to set up a channel and ESS-ID for each apparatus. In this case, wireless communication apparatus 100 acquires the setting information from the other wireless communication apparatus (for example, wireless communication apparatus 200) via the cable communication section 106. Thereby, wireless communication apparatus 100 can start a wireless communication only by connecting with the other wireless communication apparatus through cable communication section 106. In addition, wireless 1394 and Bluetooth can also be used as the wireless communication means. The connection method differs from the initialization method for every wireless communication means. This invention is thus not limited to a specific wireless communication means.

Justification check section 104 checks whether the key information has been notified to the right wireless communication apparatus (the wireless communication apparatus in the user's house) via wireless communication section 101. As a concrete example of the justification check, two pass partner authentication or message authentication generally known as a public key cryptosystem is used.

When the other wireless communication apparatus that outputted the connection request is an authorized wireless communication apparatus (a wireless communication apparatus of the user's house), justification check section 104 outputs a signal indicating that the authorization of the other wireless communication apparatus was checked (it has checked that it was a wireless communication apparatus in the user's house) to connection request answer section 102. Then, connection request answer section 102 outputs a connection request acceptance indication signal which shows that the connection request was received by the other wireless communication apparatus through wireless communication section 101. Furthermore, connection request answer section 102 also outputs the connection request acceptance signal to key information management section 105 through wireless communication apparatus existence check section 103.

On the contrary, when the other wireless communication apparatus which outputted the connection request is not an authorized wireless communication apparatus (it is not a wireless communication apparatus in the user's house), justification check section 104 outputs a signal that indicates that an unauthorized wireless communication apparatus outputted the connection request via wireless communication section 101 (it was not a wireless communication apparatus in the user's house) to connection request answer section 102. Then, connection request answer section 102 outputs a connection request acceptance indication which shows that the connection request was not acceptable to the other wireless communication apparatus through wireless communication section 101.

Key information management section 105 outputs the key information managed by encryption/decryption section 107 to the other wireless communication apparatus which outputted the connection request through cable communication section 106, when connection request answer section 102 receives the connection request. Moreover, key information management section 105 is not sent to the other wireless communication apparatus which outputted the connection request for the key information managed by encryption/decryption section 107, when connection request answer section 102 does not receive the connection request.

If the key information is inputted from key information management section 105, encryption/decryption section 107 will encrypt the transmitting data from the data process section 108, and will output the data to wireless communication section 101. Moreover, encryption/decryption section 107 decrypts the encryption data received by wireless communication section 101, and outputs it to data process section 108. However, encryption/decryption section 107 does not perform encryption/decryption processing, when the key information is not inputted from key information management section 105.

Thus, when the other wireless communication apparatus which outputted the connection request is an authorized wireless communication apparatus (the wireless communication apparatus in the user's house), communication is established. When the wireless communication apparatus which outputted the connection request is not an authorized wireless communication apparatus (it is not the domestic wireless communication apparatus in the user's house), communication is not performed

(Composition of the wireless communication apparatus which carries out a connection request)

FIG. 1 shows the wireless communication apparatus which answers the connection request. Next the composition of wireless communication apparatus 200, which carries out the connection request, will be explained in detail with reference to the FIG. 2.

FIG. 2 is a functional block diagram of a wireless communication apparatus which carries out a connection request according to an embodiment of the present invention.

The wireless communication apparatus outputs a connection request to the other wireless communication apparatus in the same house. This wireless communication apparatus correctly answers a check of whether the connection request is from a wireless communication apparatus in the same house, and establishes a connection.

First, the composition of wireless communication apparatus 200 will be explained in detail with reference to FIG. 2.

As shown in FIG. 2, wireless communication apparatus 200 a includes a wireless communication section 201, a connection request transmittal section 202, a wireless communication apparatus existence check answer section 203, a justification check answer section 204, a key information management section 205, a cable communication section 206, an encryption/decryption section 207, and a data process section 208.

Wireless communication section 201 communicates with other devices by wireless communication.

Connection request transmittal section 202 transmits the connection request to the other wireless communication apparatus.

Wireless communication apparatus existence check answer section 203 answers a check of whether it is in the same house as the other wireless communication apparatus.

Justification check answer section 204 answers an authorization check from the other wireless communication apparatus through wireless communication section 201.

Key information management section 205 manages the key information used for encryption.

Unlike wireless communication section 201, cable communication section 206 communicates with a cable.

Encryption/decryption section 207 encrypts/decrypts communication data.

Data process section 208 carries out transmission and reception processing of the communication data.

Next, an operation of the wireless communication apparatus 200 will be explained.

Connection request transmittal section 202 transmits the connection request signal to the wireless communication apparatus 100 through wireless communication section 201. Through cable communication section 106 in the wireless communication apparatus 100, which received the connection request, performs the existence check. At the time of this existence check, wireless communication apparatus existence check answer section 203 communicates with the wireless communication apparatus 100 through cable communication section 206, and correctly answers the existence check. Key information management section 205 manages the key information inputted from the wireless communication apparatus 100 through cable communication section 206 after this response.

Key information management section 205 outputs the managed key information to justification check answer section 204. After the key information is inputted into the justification check answer section 204, the wireless communication apparatus 100 checks for authorization through wireless communication section 201. At the time of this authorization check, justification check answer section 204 communicates with wireless communication apparatus 100 through wireless communication section 201, and it checks for authorization as explained above.

Connection request transmittal section 202 receives connection request acceptance signal from the wireless communication apparatus 100 through wireless communication section 201 after the authorization check. If connection request transmittal section 202 receives the connection request acceptance signal, key information management section 205 will output the managed key information to encryption/decryption section 207. The connection request acceptance signal is not sent if the wireless communication apparatus 200 is not authorized. In this case, the wireless communication apparatus 100 most likely determined that the wireless communication apparatus 200 is not in the same house as the wireless communication apparatuses 100. Also in this case, the wireless communication apparatus 200 can not communicate with the wireless communication apparatus 100.

Encryption/decryption section 207 encrypts the transmitting data inputted from data process section 208, and outputs the data to the wireless communication apparatus 100 through wireless communication section 201. Moreover, encryption/decryption section 207 decrypts the encryption data received by wireless communication section 201, and outputs that data to data process section 208.

Thus, communication is performed when the wireless communication apparatus 100, which received the connection request, determines that the wireless communication apparatus 100 and the wireless communication apparatus 200 are in the same house. Communication is not performed when the wireless communication apparatus 100, which received the connection request, determines that the wireless communication apparatus 100 and the wireless communication apparatus 200 are not in the same house.

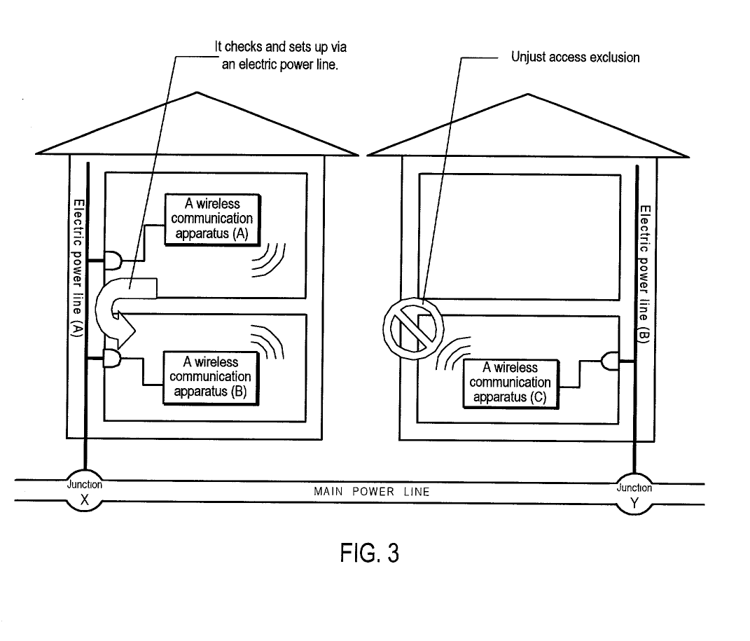

Next, a connection between wireless communication apparatuses will be explained with reference to FIG. 3.

FIG. 3 is a functional block diagram showing connection of a wireless communication apparatus in a house according to an embodiment of the present invention. In FIG. 3, wireless communication apparatus A is the wireless communication apparatus shown in FIG. 1, and wireless communication apparatus B and wireless communication apparatus C are the wireless communication apparatuses shown in FIG. 2.

Wireless communication apparatus B is in the same house as wireless communication apparatus A. For this reason, wireless communication apparatus B is authorized to connect with wireless communication apparatus A. Wireless communication apparatus B transmits a connection request signal via wireless communication to wireless communication apparatus A. Wireless communication apparatus A will transmit key information to wireless communication apparatus B via, for example, an electric power line A, if the connection request signal is received. Wireless communication apparatus A also transmits a message for an authorization check via wireless communication. Wireless communication apparatus B encrypts the message received via wireless communication using the key information received via electric power line A, and returns the message to wireless communication apparatus A. Wireless communication apparatus A decrypts the encrypted message received from the wireless communication apparatus B using the key information transmitted to wireless communication apparatus B via the electric power line A. If this signal of wireless communication apparatus A that carried out the decrypting corresponds to the message transmitted to wireless communication apparatus B, then wireless communication apparatus B will judge that it is in the same house as the wireless communication apparatus A. Wireless communication apparatus A then permits wireless communication with wireless communication apparatus B, and wireless data communication is performed between wireless communication apparatus A and wireless communication apparatus B.

On the other hand, wireless communication apparatus C is not in the same house as wireless communication apparatus A and is for a different user. Supposing wireless communication apparatus A permits the wireless connection request from wireless communication apparatus C, wireless communication apparatus C can acquire information from wireless communication apparatus A unjustly, and that is a problem.

When wireless communication apparatus C transmits a connection request signal to wireless communication apparatus A, wireless communication apparatus A transmits key information to wireless communication apparatus C via electric power line A, like the case of wireless communication apparatus B. However, wireless communication apparatus C is connected to electric power line B of the house of the different user from wireless communication apparatus A instead of the same electric power line A as wireless communication apparatus A. Wireless communication apparatus C can not receive the key information from wireless communication apparatus A. Therefore, wireless communication apparatus C can not answer the justification check from wireless communication apparatus A. Consequently, wireless communication apparatus A judges the connection request from wireless communication apparatus C to be an unjust connection, and cancels it.

As shown in FIG. 3, the electric power line A and the electric power line B both connect to a main power line. The connection junctions X and Y, however, will prevent a communication signal on power line A from reaching power line B. The connection junctions for example, may comprise electric power meters.

A connection request is permitted between the same user's apparatuses, and a connection request is canceled between the apparatuses of a different user's house as explained above.

In addition, FIG. 3 shows an electric power line embodiment. However, the electric power line is only one example embodiment communication with a cable.

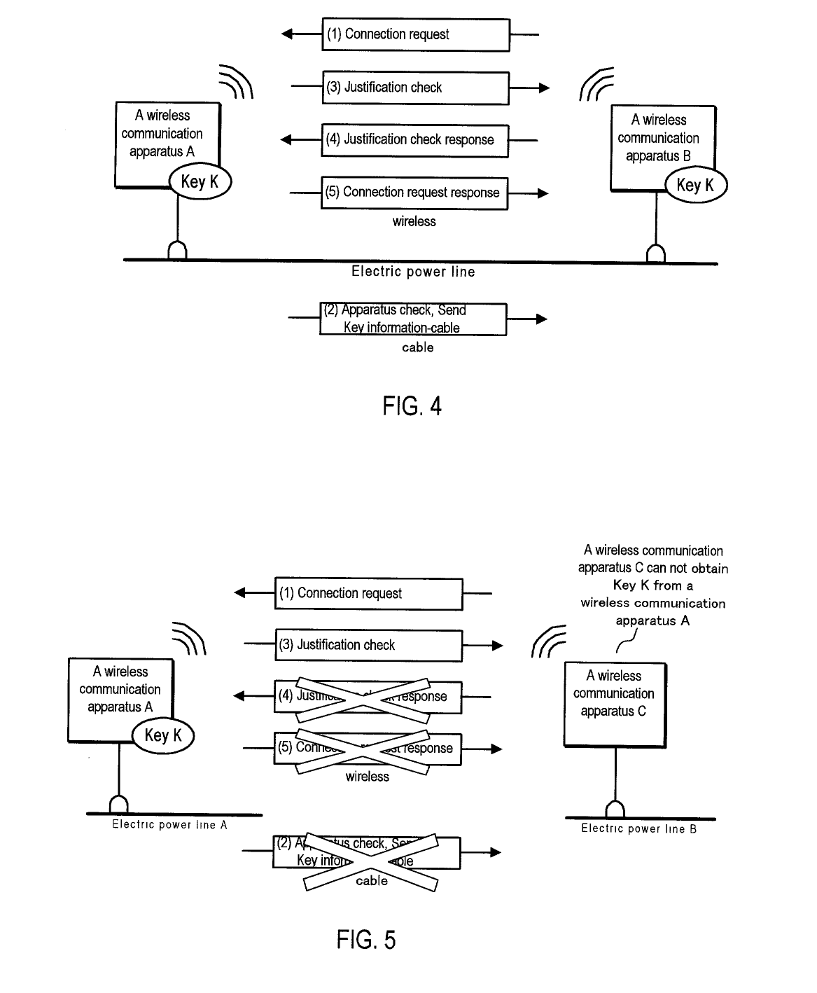

Next, a wireless connection will be explained with reference to FIG. 4.

FIG. 4 schematically shows a wireless connection operation according to an embodiment of the present invention.

(Procedure 1)

In FIG. 4, a connection request is transmitted from wireless communication apparatus B to wireless communication apparatus A.

(Procedure 2)

Next, a key information (Key K) is transmitted from wireless communication apparatus A via an Electric power line (cable) to wireless communication apparatus B.

(Procedure 3)

Wireless communication apparatus A checks the authorization of the connection request apparatus(wireless communication apparatus B).

(Procedure 4)

Wireless communication apparatus B answers the justification check.

(Procedure 5)

The wireless communication apparatus A, after the authorization check, acknowledges the connection request from wireless communication apparatus B to wireless communication apparatus B. Consequently, data communication is performed between wireless communication apparatus A and wireless communication apparatus B.

Next, the procedure for eliminating an unjust wireless connection according to an embodiment will be explained with reference to FIG. 5.

FIG. 5 schematically shows an operation for eliminating an unjust wireless connection according to an embodiment of the present invention. In FIG. 5, (Procedure 1) a connection request signal is transmitted from wireless communication apparatus C to the wireless communication apparatus A.

Wireless communication apparatus A, which received the connection request signal from wireless communication apparatus C, sends key information (Key K) via electric power line A. However, because wireless communication apparatus C is connected to electric power line B, which differs from electric power line A, wireless communication apparatus C can not receive the key information from wireless communication apparatus A. For this reason, wireless communication apparatus C can not return the right response (Procedure 4 to Procedure 3) to wireless communication apparatus A. For this reason, the connection request (Procedure 5) is canceled. It becomes impossible consequently, to carry out the wireless communication from wireless communication apparatus C to wireless communication apparatus A.

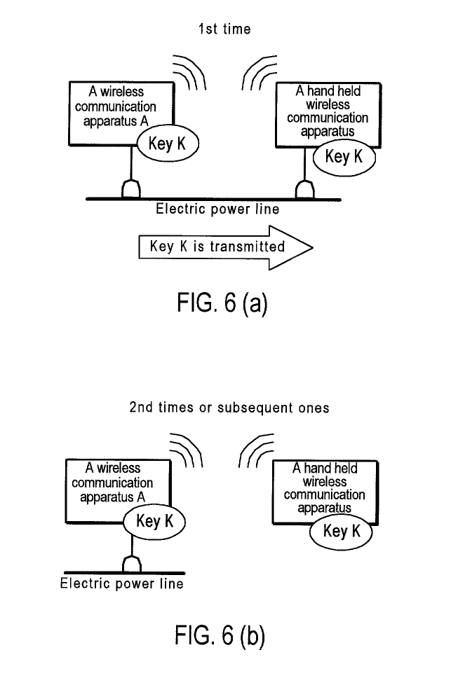

Next, a wireless connection with a hand held wireless communication apparatus according to an embodiment will be explained with reference to FIGS. 6(a) and 6(b).

FIG. 6(a) and 6(b) schematically show a connection method with a hand held wireless communication apparatus according to an embodiment of the present invention. Hand held wireless communication apparatuses, such as mobile audio players, are usually separated from the electric power line, in order that the place to be used may move. For this reason, the hand held wireless communication apparatus can not be checked via an electric power line at the time of a connection request.

In this invention, in the case of the hand held wireless communication apparatus, the key information (Key K) is only transmitted once via the charge adapter as shown in FIG. 6(a). Then, the hand held wireless communication apparatus uses for the authorization check the key information (Key K) held in memory in FIG. 6(a) from wireless communication apparatus A as is shown in FIG. 6(b). Thereby, the hand held wireless communication apparatus can answer correctly, and can perform wireless data communication.

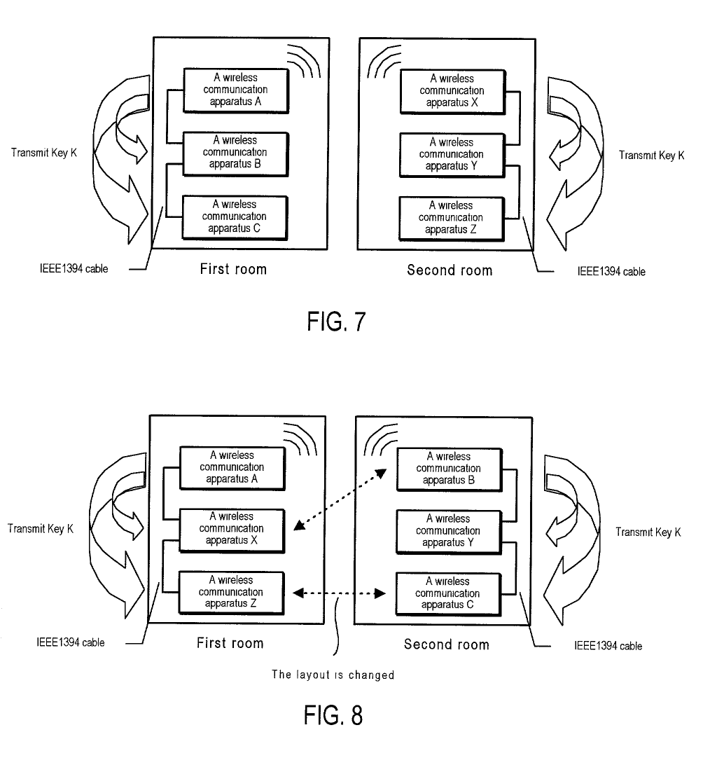

Next, the case where IEEE1394 of the cable is used as another different communication means from the wireless communication means will be explained with reference to FIGS. 7 and 8.

FIGS. 7 and 8 are diagrams for explaining when IEEE1394 of the cable is used as another different means of communication from the wireless communication means. In FIG. 7, wireless communication apparatus A, wireless communication apparatus B, and wireless communication apparatus C are arranged in a 1st room. These apparatuses A, B, and C are connected through IEEE1394 of the cable in the 1st room, respectively. Wireless communication apparatus X, wireless communication apparatus Y, and wireless communication apparatus Z are arranged in a 2nd room. These apparatuses X, and Y and Z are connected through IEEE1394 of the cable in the 2nd room, respectively. However, IEEE1394 arranged in the 1st room and IEEE1394 arranged in the 2nd room are not connected with a cable.

By the conventional system, if the user did not set the key information for all wireless communication apparatuses, such as wireless communication apparatus B and wireless communication apparatus Y besides wireless communication apparatus A and wireless communication apparatus X, wireless connection between all apparatuses can not be completed.

In this embodiment, an exchange of key information is first performed by the conventional method by the user between wireless communication apparatus A and wireless communication apparatus X. In this case, wireless communication apparatus A also transmits the key information via a IEEE1394 of the cable to wireless communication apparatus B and wireless communication apparatus C which are connected by the IEEE1394 of the cable. Wireless communication apparatus X transmits the key information to wireless communication apparatus Y and wireless communication apparatus Z similarly. By setting up only wireless communication apparatus A and wireless communication apparatus X, the user sets up all of the wireless apparatuses in both the first and second rooms.

After the wireless setup shown in FIG. 7, the movement of a wireless communication apparatus between the 1st room and the 2nd room will be explained with reference to FIG. 8. In FIG. 8, wireless communication apparatus B and wireless communication apparatus C move to the 2nd room from the 1st room, and are connected with wireless communication apparatus Y through IEEE1394 of the cable. Moreover, wireless communication apparatus X and wireless communication apparatus Z move to the 1st room from the 2nd room, and are connected with wireless communication apparatus A through IEEE1394 of the cable.

For example, the wireless connection between wireless communication apparatus A and wireless communication apparatus B will be explained as follows.

By the conventional system, only a wireless connection setup with wireless communication apparatus A and wireless communication apparatus X is performed before the layout change. For this reason, by layout change of apparatus, the user newly needs to set up wireless communication apparatus A and wireless communication apparatus B which have been separated to another room.

Wireless communication apparatus A and wireless communication apparatus B setup a wireless connection between wireless communication apparatus A and wireless communication apparatus X reflected in wireless communication apparatus B through an IEEE1394 cable, when connecting by IEEE1394 of the cable. For this reason, even when wireless communication apparatus B moves to another room without a new cable connection, wireless communication can be performed between wireless communication apparatus A and wireless communication apparatus B, without newly setting up wireless communication apparatus A and wireless communication apparatus B.

Thus, wireless communication begins immediately because a prior setup was performed when connected, as shown in FIG. 7, through IEEE1394 of the cable by using the key information currently held in memory, though a layout change was made as shown in FIG. 8.

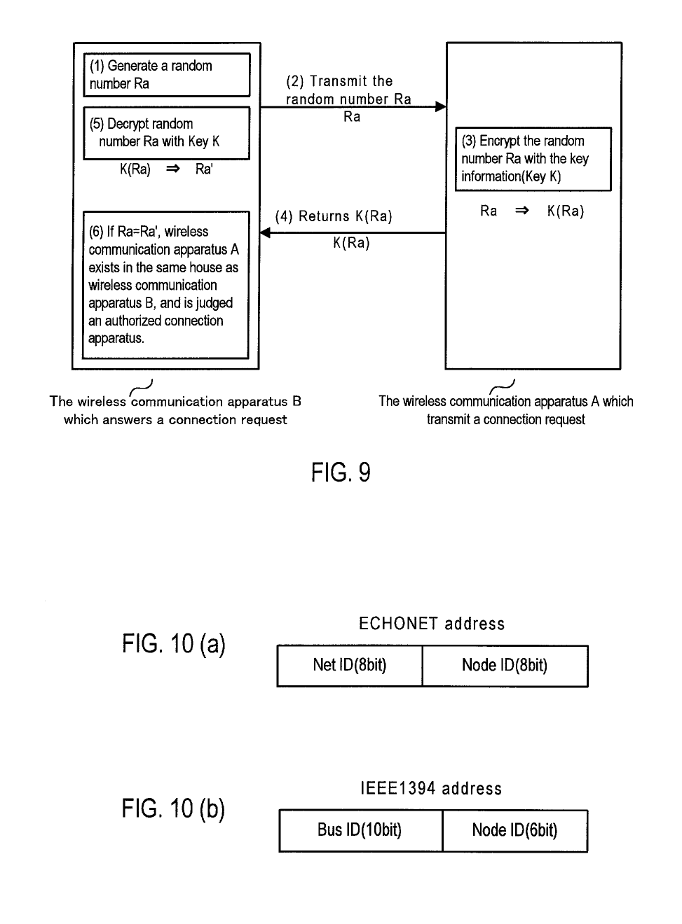

Next, an example of a justification check will be explained with reference to FIG. 9.

FIG. 9 schematically shows an example justification check between a wireless communication apparatus which answers a connection request, and another wireless communication apparatus which carries out a connection request according to an embodiment of the present invention.

Here, an example justification check by general two pass partner authentication is shown. The attestation method is, however, is not limited to this method, and other methods may be used within the spirit and scope of this invention.

The wireless communication apparatus which transmits a connection request signal is judged by holding the same key information as the wireless communication apparatus which answers the connection request signal.

If it is a wireless communication apparatus in the same user's house, the key information can be correctly transmitted via cables, such as the electric power line. Therefore, if the key information is held, it can be judged as the wireless communication apparatus in the same user's house.

Next, an example justification check when wireless communication apparatus A transmits a connection request signal to wireless communication apparatus B will be explained.

(Procedure 1)

First, wireless communication apparatus B which answers the connection request signal transmitted from wireless communication apparatus A generates a random number Ra.

(Procedure 2)

Wireless communication apparatus B which answers the connection request signal transmits the random number Ra to wireless communication apparatus A.

(Procedure 3)

Wireless communication apparatus A encrypts the random number Ra with the key information(Key K) which is the key information stored in a memory.

(Procedure 4)

Wireless communication apparatus A returns K(Ra) which is the signal encrypted in Procedure 3 to wireless communication apparatus B.

(Procedure 5)

Wireless communication apparatus B obtains Ra by decrypting K(Ra) received from wireless communication apparatus A with the key information(Key K) stored in the memory in wireless communication apparatus B. Wireless communication apparatus B then compares the random number Ra which wireless communication apparatus B transmitted in Procedure 1 with the random number Ra′ obtained in Procedure 5. If the random number Ra′ is the same as the random number Ra, the wireless communication apparatus A has the same key information(Key K) as wireless communication apparatus B. In short, wireless communication apparatus A exists in the same house as wireless communication apparatus B, and is judged an authorized connection apparatus.

Next, the apparatus identification information transmitted from the apparatus which required connection at the time of the connection request of the wireless communication apparatus in this embodiment will be explained with reference to FIG. 10.

FIGS. 10(a) and 10(b) are diagrams showing examples of apparatus identification information transmitted from a connection request apparatus at the time of a connection request according to an embodiment of the present invention. The ECHONET address shown in FIG. 10(a) is the address used in the ECHONET, a domestic network standard electric power line communication. This address consists of an 8-bit NetID (Network ID) and an 8-bit NodeID (node ID). The IEEE1394 address shown in FIG. 10(b) is the address used for communication using the IEEE1394 standard. This address consists of a 10-bit BusID and a 6-bit NodeID. The wireless communication apparatus which answers the connection request signal transmits the key information to the wireless communication apparatus with the address information.

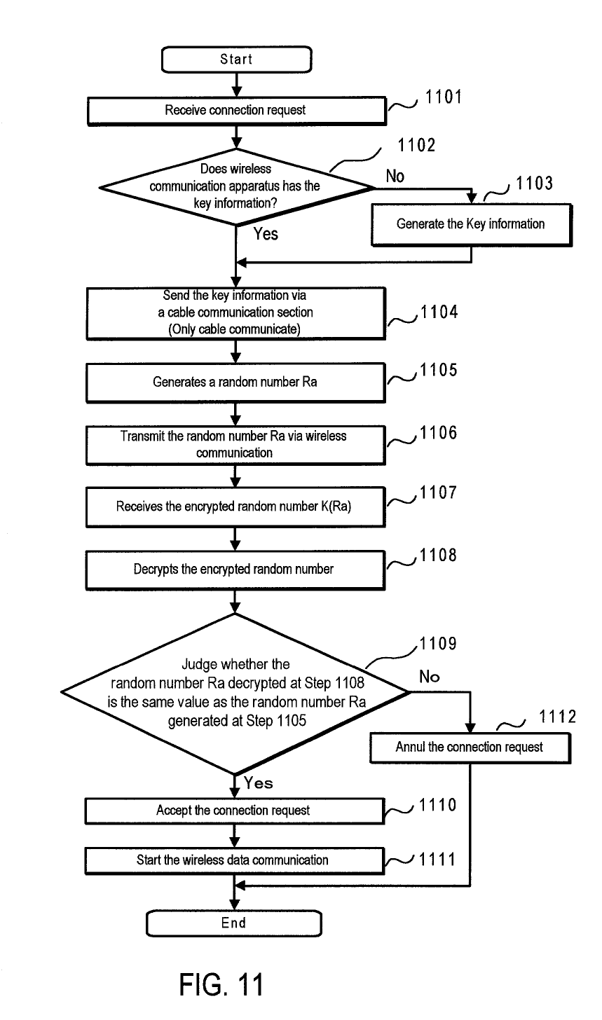

Next, an operation of wireless communication apparatus B answering the connection request will be explained with reference to FIG. 11.

FIG. 11 is a flowchart showing an answering operation of a connection request in a wireless communication apparatus B which answers a connection request according to an embodiment of the present invention. In FIG. 11, wireless communication apparatus B receives the connection request signal from wireless communication apparatus A (Step 1101). Next, wireless communication apparatus B checks whether wireless communication apparatus A already has the key information (Step 1102).

In Step 1102, when wireless communication apparatus A does not have the key information, wireless communication apparatus B generates the key information (Step 1103). Operation of wireless communication apparatus B then progresses to Step 1104. Moreover, in Step 1102, when wireless communication apparatus A already has the key information, operation of wireless communication apparatus B progresses to Step 1104.

In Step 1104, wireless communication apparatus B sends the key information to wireless communication apparatus A via cable communication section 106.

Wireless communication apparatus B generates a random number Ra (Step 1105), and transmits the random number Ra to wireless communication apparatus A via wireless communication section 101 (Step 1106).

Wireless communication apparatus A receives the random number Ra from wireless communication apparatus B via wireless communication section 201. Wireless communication apparatus A encrypts this received random number Ra using key information K, and returns an encrypted random number K(Ra) to wireless communication apparatus B.

Wireless communication apparatus B receives the encrypted random number K(Ra) encrypted by wireless communication apparatus A (Step 1107), and decrypts the encrypted random number (Step 1108).

Wireless communication apparatus B judges whether the random number Ra decrypted at Step 1108 is the same value as the random number Ra generated at Step 1105 (Step 1109).

When the value are the same in Step 1109, wireless communication apparatus B accepts the connection request from wireless communication apparatus A (Step 1110). Wireless communication apparatus B receives the connection request from wireless communication apparatus A, when the judgment values are the same in Step 1109 (Step 1110). Wireless communication apparatus B then starts the wireless data communication (Step 1111). Contrarily, when the judgment values are not the same in Step 1109, wireless communication apparatus B annuls the connection request from wireless communication apparatus A (Step 1112).

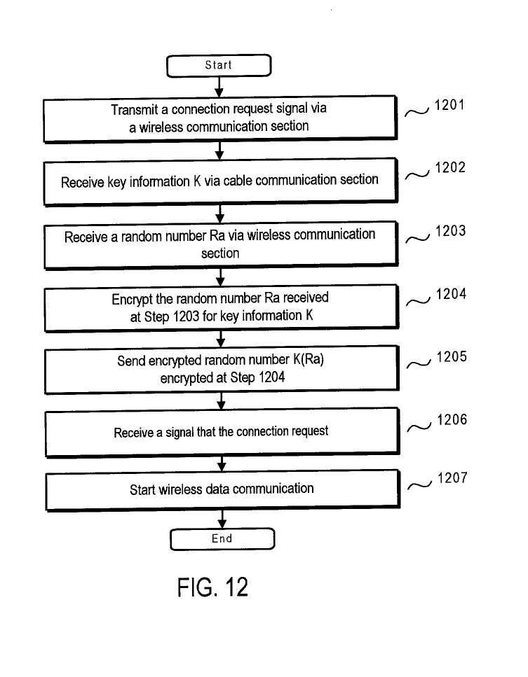

Next, operation at the time of the connection request in wireless communication apparatus A will be explained with reference to FIG. 12.

FIG. 12 is a flowchart showing an operation when carrying out a connection request in a wireless communication apparatus A which carries out a connection request according to an embodiment of the present invention. In FIG. 12, wireless communication apparatus A transmits a connection request signal to wireless communication apparatus B via wireless communication section 201 (Step 1201).

Next, wireless communication apparatus A receives key information K from wireless communication apparatus B via cable communication section 206 (Step 1202).

Next, wireless communication apparatus A receives a random number Ra from wireless communication apparatus B via wireless communication section 201 (Step 1203).

Next, wireless communication apparatus A encrypts the random number Ra received at Step 1203 for key information K (Step 1204).

Next, wireless communication apparatus A sends encrypted random number K(Ra) encrypted at Step 1204 to wireless communication apparatus B (Step 1205).

Next, wireless communication apparatus A receives a signal that the connection request was received, when the connection request signal is received by wireless communication apparatus B (Step 1206). Wireless communication apparatus A then starts wireless data communication with wireless communication apparatus B (Step 1207).

In addition, when the communication device of this invention is connected to an electric power line, this electric power line forms the breaker apparatus which transmits information to another electric power line in the same house. Consequently, it can distinguish correctly that the communication apparatus of this invention is an apparatus in a user's house, though the electric power line was divided into two or more systems on both sides of the breaker in the same house.

Moreover, the apparatus identification information for discriminating an apparatus may be the setting information for a wireless communication. If so, the detailed setup required for wireless communication is omitted for the apparatus which requires connection.

In this invention, a safe wireless communication network can be built without setting many set up by the user.

Other embodiments of the invention will be apparent to those killed in the art from consideration of the specification and practice of the invention disclosed herein. It is intended that the specification and examples be considered as exemplary only, with the true scope and spirit of the invention being indicated by the following claims.

What is claimed is:

1. A communication apparatus, comprising;
means for wireless-communicating to a second communication apparatus;
means for cable-communicating to the second communication apparatus;
means for determining whether the cable-communication is possible; and
means for controlling wireless communication according to the result of the means for determining.

2. A wireless communication apparatus, comprising;
means for wireless-communicating to a second communication apparatus;
means for cable-communicating to the second communication apparatus;
means for checking existence of the second communication apparatus through the means for cable-communicating;
means for transmitting apparatus discrimination information for discriminating one communication apparatus from the second communication apparatus through the means for cable-communicating after the existence of the second communication apparatus is checked through the means for cable-communicating;
means for checking whether the second communication apparatus stores the apparatus discrimination information through the means for wireless-communicating; and
means for controlling wireless data communication with the second communication apparatus according to the result of the means for checking whether the second communication apparatus stores the apparatus discrimination information.

3. A wireless communication apparatus, comprising;
means for wireless-communicating to a second communication apparatus;
means for cable-communicating to the second communication apparatus;
means for answering an existence check request from the second communication apparatus through the means for cable-communicating;
means for receiving apparatus discrimination information through the means for cable-communicating; and
means for answering a possession check request with the apparatus discrimination information through the means for wireless-communicating.

4. A wireless communication apparatus, comprising;
means for wireless-communicating to a second communication apparatus;
means for cable-communicating to the second communication apparatus;
means for transmitting key information to the second communication apparatus through the means for cable-communicating;
means for transmitting predetermined data to the second communication apparatus through the means for wireless-communicating;
means for receiving, from the second communication apparatus, the predetermined data encrypted using the key information;
means for decrypting the encrypted data using the key information; and
means for judging whether data from the means for decrypting is the same as the predetermined data.

5. A wireless communication apparatus, comprising;
means for wireless-communicating to a second communication apparatus;
means for cable-communicating to the second communication apparatus;
means for receiving key information from the second communication apparatus through the means for cable-communicating;
means for receiving predetermined data from the second communication apparatus through the means for wireless-communicating;
means for encrypting the predetermined data using the key information; and
means for transmitting the encrypted data to the second communication apparatus.

6. A wireless communication apparatus according to claim 5, further comprising;
memory means for storing the key information;
wherein the means for transmitting the encrypted data transmits through the means for wireless-communicating if a cable connection through the means for cable-communicating is not made.

7. A wireless communication apparatus according to claim 2 or 3, wherein the apparatus discrimination information is key information for data encryption.

8. A wireless communication apparatus according to claim 2 or 3, wherein the apparatus discrimination information is setting information for a wireless communication.

9. A wireless communication apparatus according to claim 2 or 3, wherein the means for cable-communicating comprises an IEEE1394 cable network or an electric power line.

10. A wireless communication apparatus according to claim 7, further comprising;
means for forwarding the key information to an electric power line, wherein the electric power line is connected to the means for cable-communicating.
